(19) United States
(12) Patent Application Publication
(10) Pub. No.: US 2025/0103362 A1
(43) Pub. Date: Mar. 27, 2025

(54) IMPLEMENTING UI TASK AUTOMATION WITH GUIDED TEACHING

(71) Applicant: International Business Machines Corporation, Armonk, NY (US)

(72) Inventors: Avi YAELI, Ramot Menashe (IL); Sami MARREED, Kafer Kanna (IL); Segev SHLOMOV, Haifa (IL); Asaf ADI, Kiryat Ata (IL); Nir MASHKIF, Geva Carmel (IL); Offer AKRABI, Lehavot Habashan (IL); Netanel EDER, Tel-Mond (IL)

(21) Appl. No.: 18/474,910

(22) Filed: Sep. 26, 2023

(51) Int. Cl. G06F 9/455; G06F 9/451

(52) U.S. Cl. CPC G06F 9/45512; G06F 9/453

(57) ABSTRACT

Embodiments of the present disclosure provide methods, systems, and computer program products for implementing user interface (UI) Task Automations. Disclosed embodiments include receiving an automation structure and inputs and outputs of the structure to create a task automation, and providing multi-modal interfaces to process one or more teaching demonstrations for the task automation, where the teaching demonstrations identify automation processing parameters and operations for the task automation. Interactive contextual guidance are generated to record conditional execution of one or more actions or expressions based on states of one or more UI elements of the teaching demonstrations. Disclosed embodiments include recording, based on the conditional execution of one or more actions or expressions, the teaching demonstrations, synthesizing a UI task automation program of the task automation from the teaching demonstrations, and presenting the UI task automation program for validation.

### BACKGROUND

The present invention relates to digital data processing, and more specifically, to methods, systems, and computer program products for implementing user interface (UI) Task Automations with guided teaching to generate a UI task automation program.

UI Task Automations are generally complex, and typically require a programmer to build a UI Task Automation program, also called a digital labor, software robot, digital robot, or a Robotic Process Automation (RPA) bot. A non-technical user (e.g., business user) typically lacks an understanding of programming concepts needed to create a customized UI Task Automation program or digital labor. For example, a non-technical user may lack the technical ability or programming skills for technical challenges, such as related to referencing UI elements using static and dynamic selectors, and defining a Document Object Model (DOM) data representation of objects.

### SUMMARY

Embodiments of the present disclosure provide methods, systems, and computer program products for implementing user interface (UI) Task Automations with guided teaching to generate a UI task automation program.

According to one embodiment of the present disclosure, a non-limiting computer implemented method is provided. The method includes receiving an automation structure and inputs and outputs of the structure to create a given task automation; providing multi-modal interfaces to receive an input and process one or more teaching demonstrations for the task automation, where the one or more teaching demonstrations identify automation processing parameters and operations for the task automation. The method also includes generating interactive contextual guidance to record conditional execution of one or more actions or expressions based on states of one or more User Interface (UI) elements of the one or more teaching demonstrations; recording the one or more teaching demonstrations; synthesizing a UI task automation program from the one or more teaching demonstrations; and presenting a visual program representation of the UI task automation program for validation.

According to one embodiment of the present disclosure, a system is provided. The system includes one or more computer processors, and a memory containing a program which when executed by the one or more computer processors performs an operation. The operation includes receiving an automation structure and inputs and outputs of the structure to create a given task automation; providing multi-modal interfaces to receive an input and process one or more teaching demonstrations for the task automation, where the one or more teaching demonstrations identify automation processing parameters and operations for the task automation. The operation also includes generating interactive contextual guidance to record conditional execution of one or more actions or expressions based on states of one or more User Interface (UI) elements of the one or more teaching demonstrations; recording the one or more teaching demonstrations; synthesizing a UI task automation program from the one or more teaching demonstrations; and presenting a visual program representation of the UI task automation program for validation.

According to one embodiment of the present disclosure, a computer program product is provided. The computer program product includes a computer-readable storage medium having computer-readable program code embodied therewith, the computer-readable program code executable by one or more computer processors to perform an operation. The operation includes receiving an automation structure and inputs and outputs of the structure to create a given task automation; providing multi-modal interfaces to receive an input and process one or more teaching demonstrations for the task automation, where the one or more teaching demonstrations identify automation processing parameters and operations for the task automation. The operation also includes generating interactive contextual guidance to record conditional execution of one or more actions or expressions based on states of one or more User Interface (UI) elements of the one or more teaching demonstrations; recording the one or more teaching demonstrations; synthesizing a UI task automation program from the one or more teaching demonstrations; and presenting a visual program representation of the UI task automation program for validation.

### BRIEF DESCRIPTION OF THE DRAWINGS

FIG. 1 is a block diagram of an example computer environment for use in conjunction with one or more disclosed embodiments for implementing for implementing user interface (UI) Task Automation with guided teaching of UI task automation or digital labor;

FIG. 2 is a block diagram of an example system for implementing a UI Task Automation of one or more disclosed embodiments;

FIGS. 3A and 3B together provide a flow chart of example operations of an example method for implementing UI Task Automation of one or more disclosed embodiments;

FIG. 4 is a block diagram illustrating an automation structure for implementing example defining operations of UI Task Automation of one or more disclosed embodiments;

FIGS. 5, 6, and 7 together provide a block diagram illustrating logical automation structures of a UI Task Automation of one or more disclosed embodiments;

FIG. 8 is a block diagram illustrating an automation structure for implementing example teaching operations of UI Task Automation of one or more disclosed embodiments; and

FIG. 9 is a flow chart of a method for implementing UI Task Automation of one or more disclosed embodiments.

### DETAILED DESCRIPTION

According to an aspect of disclosed embodiments, there is provided a non-limiting computer implemented method. The method comprises receiving an automation structure and inputs and outputs of the structure to create a given task automation; providing multi-modal interfaces to receive an input and process one or more teaching demonstrations for the task automation, where the one or more teaching demonstrations identify automation processing parameters and operations for the task automation. The method also includes generating interactive contextual guidance to record conditional execution of one or more actions or expressions based on states of one or more UI elements of the one or more teaching demonstrations; recording the one or more teaching demonstrations; synthesizing a UI task automation program from the one or more teaching demonstrations; and presenting a visual program representation of the UI task automation program for validation. The method enables implementing complex user interface (UI) Task Automation with no-code guided teaching of digital labor to synthesize the UI task automation program by a non-technical user. The method enables enhanced processing speed (e.g., within a few minutes) for generating complex UI automation logic, including definition, teaching, and validation of the synthesized UI task automation program. The method enables effective and efficient generation of UI task automation programs, without require technical or programming user skills.

According to an aspect of disclosed embodiments, there is provided a system comprising one or more computer processors, and a memory containing a program which when executed by the one or more computer processors performs an operation. The operation comprises receiving an automation structure and inputs and outputs of the structure to create a given task automation; providing multi-modal UI interfaces to receive an input and process one or more teaching demonstrations for the task automation, where the one or more teaching demonstrations identify automation processing parameters and operations for the task automation. The operation also includes generating interactive contextual guidance to record conditional execution of one or more actions or expressions based on states of one or more UI elements of the one or more teaching demonstrations; recording the one or more teaching demonstrations; synthesizing a UI task automation program from the one or more teaching demonstrations; and presenting a visual program representation of the UI task automation program for validation. The system enables implementing complex user interface (UI) Task Automation with no-code guided teaching of digital labor to synthesize the UI task automation program by a non-technical user. The system enables enhanced processing speed for generating complex UI automation logic, including definition, teaching, and validation of the synthesized UI task automation program. The system enables effective and efficient generation of UI task automation programs, without require technical or programming user skills.

According to an aspect of disclosed embodiments, there is provided a computer program product. The computer program product comprising a computer-readable storage medium having computer-readable program code embodied therewith, the computer-readable program code executable by one or more computer processors to perform an operation. The operation comprises receiving an automation structure and inputs and outputs of the structure to create a given task automation; providing multi-modal UI interfaces to receive an input and process one or more teaching demonstrations for the task automation, where the one or more teaching demonstrations identify automation processing parameters and operations for the task automation. The operation also includes generating interactive contextual guidance to record conditional execution of one or more actions or expressions based on states of one or more UI elements of the one or more teaching demonstrations; recording the one or more teaching demonstrations; synthesizing a UI task automation program from the one or more teaching demonstrations; and presenting a visual program representation of the UI task automation program for validation. The computer program product enables implementing complex user interface (UI) Task Automation with no-code guided teaching of digital labor to synthesize the UI task automation program for a non-technical user. The computer program product enables enhanced processing speed for generating complex UI automation logic, including definition, teaching, and validation of the synthesized UI task automation program. The computer program product enables effective and efficient generation of UI task automation programs, without require technical or programming user skills.

An embodiment of the present disclosure further includes analyzing the UI task automation program; and generating user guidance and providing the multi-modal interfaces to process one or more additional teaching demonstrations. The embodiment enables automatically synthesizing the one or more additional teaching demonstrations into a consistent UI task automation program, which enables performing additional checking and identifying additional automation operations and parameters.

An embodiment of the present disclosure further includes translating the one or more teaching demonstrations into at least one logical abstract representation of the task automation; and where presenting the visual program representation of the UI task automation program is based on the at least one logical abstract representation. Enhanced overall processing time for evaluation of the synthesized UI task automation program may be enabled with the at least one logical abstract representation.

Additionally, an embodiment of the present disclosure where translating the one or more additional teaching demonstrations into the at least one logical abstract representation of the task automation further comprises combining multiple automation actions into one logical action in the at least one logical abstract representation of the task automation to present for user understanding. Enhanced overall processing time for evaluation of the synthesized UI task automation program may be enabled with combining multiple automation actions into one logical action in the at least one logical abstract representation, without showing details of computations and actions of the multiple automation actions, to enhance user understanding.

Additionally, an embodiment of the present disclosure where generating the interactive contextual guidance further comprises generating the interactive contextual guidance to enable a user to select at least one automation action or expression on at least one UI element. Enhanced overall processing time may be enabled to record one or more teaching demonstrations and synthesize the UI task automation program with the user selection of the at least one automation action or expression on at least one UI element.

Additionally, an embodiment of the present disclosure where receiving the automation structure further comprises prompting, and presenting graphical visual metaphors, to a user to receive user selected definitions for the automation structure, and the one or more inputs and outputs of the automation structure to create the task automation. Enhanced overall processing time may be enabled with the graphical visual metaphors to receive user-selected definitions to create the task automation.

Additionally, an embodiment of the present disclosure where presenting the visual program representation of the UI task automation program further comprises providing at least one interactive tool with the visual program representation to enable user understanding and validating the UI task automation program. Enhanced overall processing time for evaluation of the synthesized UI task automation program may be enabled with the at least one interactive tool providing user guidance to understand and validate the UI task automation program.

Additionally, an embodiment of the present disclosure where presenting the visual program representation of the UI task automation program further comprises enabling a user to accept and store the UI task automation program. This embodiment enable efficient and effective access to the UI task automation program with the user enabled to accept and store the UI task automation program.

Additionally, an embodiment of the present disclosure where recording, based on the conditional execution of the one or more actions or expressions, the one or more teaching demonstrations further comprises automatically detecting at least one program parameter from the one or more teaching demonstrations, and recording the at least one program parameter with the one or more teaching demonstrations. This embodiment, by automatically detecting the at least one program parameter, enables enhanced processing time to record the one or more teaching demonstrations for the task automation and synthesize the UI task automation program from the one or more teaching demonstrations.

Additionally, an embodiment of the present disclosure where presenting the visual program representation of the UI task automation program further comprises performing the UI task automation program to display a sequence of UI operations and screens to validate behavior of the UI task automation program. Enhanced overall processing time for evaluation of the synthesized UI task automation program may be enabled by the displaying the sequence of UI operations and screens of the UI task automation program.

In a disclosed embodiment, teaching of digital labor or a task automation includes prompting, and providing guidance to a user, to enable user-selected definitions for the automation type and to receive user selections of a given structure and inputs and outputs of the structure to create a task automation. In one embodiment, multi-modal interfaces are provided to enable the user to perform one or more teaching demonstrations for the task automation, without requiring technical or programming user skills. A disclosed embodiment enables multimodal human-computer interaction through natural modes of communication, interfacing users with automated systems in both input and output. A disclosed embodiment, enables interacting through multiple input modalities, such as keyboard entries, mouse interactions, and natural language utterances, and receiving information through output modalities combining multiple input modalities according to temporal and contextual constraints in order to analyze and derive semantic actions to update the task automation structure.

In a disclosed embodiment, one or more of keyboard entries, mouse interactions, and natural language utterances of each teaching demonstration are recorded. In a disclosed embodiment, semantic actions from the teaching demonstration are captured, and semantic actions can be attached to an element of an abstract syntax or structure, with additional processing on abstract tree nodes defined, (e.g., to enable a node to perform semantic checking, and/or to declare variables and variable scope). A disclosed embodiment records conditional execution of the task automation based on states of the one or more UI elements, with the user selecting a UI element on the screen. A disclosed embodiment provides, using an in-context advisor tool, automatic user guidance for the user to define one or more actions or expressions that are relevant to the selected UI element. In one embodiment, each teaching demonstration is recorded and one or more teaching demonstrations translated into an intermediate logical abstract representation of the task automation. A disclosed embodiment provides interactive contextual guidance to enable the user to define one or more actions or expressions on one or more UI elements of the task automation. In a disclosed embodiment, one or more teaching demonstrations to process are suggested to the user, and entering another teaching mode is enabled for the user. In a disclosed embodiment, interactive contextual guidance prompts include voice natural language (NL) utterances, for example enabling the user to define business names, conditions, and decisions with NL utterances. In a disclosed embodiment, a task automation program of the task automation is synthesized from the one or more teaching demonstrations, and presents the task automation program for review and validation by the user to confirm correct performance of the task automation. In a disclosed embodiment, a program map is presented to provide a consolidated view of the teaching demonstration logic. In a disclosed embodiment, an automation view of step-by-step operations of the teaching demonstration logic are presented, enabling validation by the user.

A disclosed embodiment enables validation, performing the UI task automation program, and providing guidance tools for understanding whether the task automation is performed correctly, such as providing a flow of UI operations and screens enabling the user to understand and validate the UI task automation program. Disclosed embodiments present graphical visual metaphors to the user for a single teaching demonstration (e.g., a single scenario) and for the complete UI task automation program. A disclosed embodiment enables validation by the user, by performing the UI task automation program to provide a flow, or sequence, of UI operations and screens for the user to determine whether the task automation program performs correctly.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

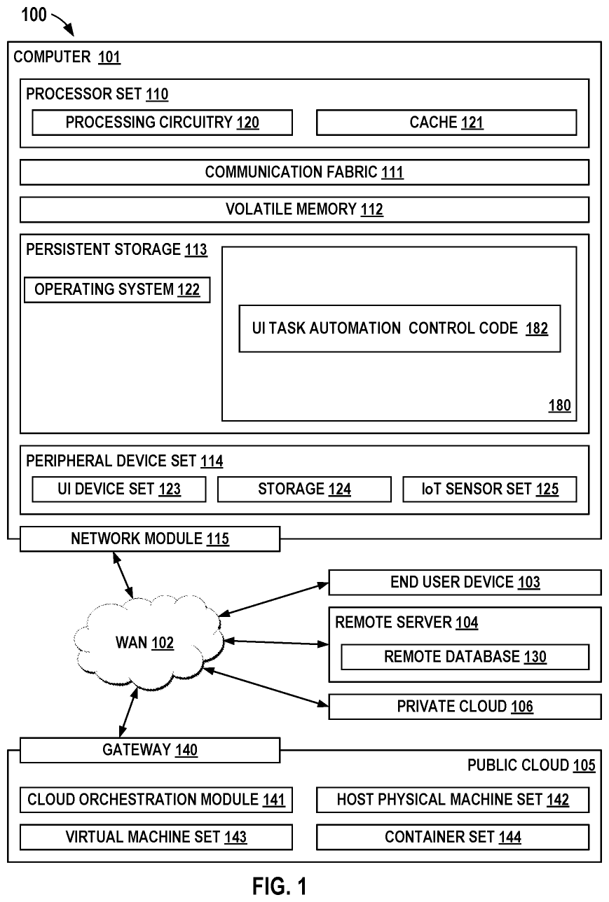

Referring to FIG. 1, a computing environment 100 contains an example of an environment for the execution of at least some of the computer code involved in performing the inventive methods, such as a UI Automation Task Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed embodiments enable generation of a UI Task Automation program by a non-technical user, enabling the user to perform one or more teaching demonstrations, and synthesizing a UI task automation program of a task automation from the one or more teaching demonstrations for review and validation by the user.

In accordance with features of disclosed embodiments of methods, systems, and computer program products, users are enabled to define an automation, by a user-selected structure or template and one or more inputs and outputs of the structure. The disclosed embodiments enable users to record multiple teaching demonstrations, or execution scenarios corresponding to different business situations, via keyboard and mouse interactions and through natural language utterances. The disclosed embodiments enable recording conditional execution based on states of UI elements, by enabling users to select an element on the screen and providing automatic user guidance on Boolean expressions that are relevant to the selected elements. The disclosed embodiments automatically merge of multiple scenarios (e.g., teaching demonstrations) into a consistent program. The disclosed embodiments surface a higher-level visual program representation that non-technical business users can understand. The disclosed embodiments enable users to perform automation validation that allows the user to check coverage, and that prompts the user, suggesting additional demonstrations to perform, and enables users to perform debugging to review the UI task automation program (i.e., constructed digital labor bot) in action and validate correctness of its behavior on sample data.

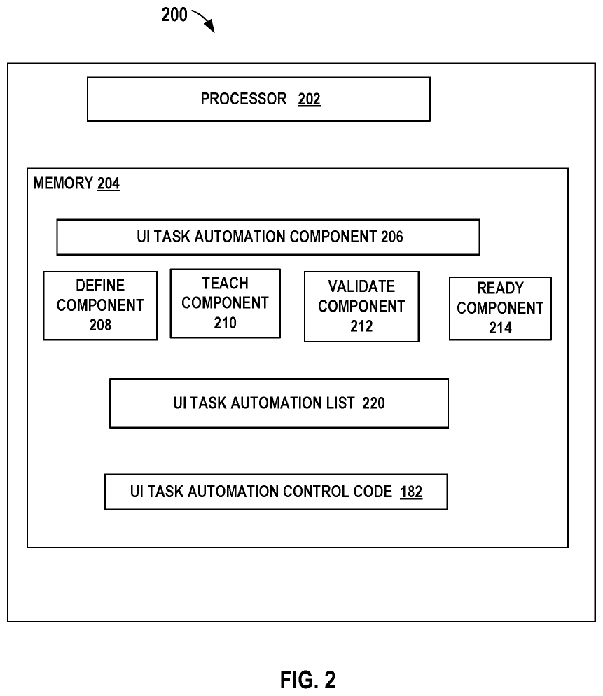

Referring now to FIG. 2, an example system 200 is shown for implementing UI Task Automation of one or more disclosed embodiments. The system 200 can be used in conjunction with the computer 101 and cloud environment of the computing environment 100 of FIG. 1 with the UI Automation Task Control Code 182 for implementing UI Task Automation of disclosed embodiments. In a disclosed embodiment, the system 200 enables effective and efficient generation of UI Task Automations by a non-technical user.

In a disclosed embodiment, system 200 includes one or more processors 202, and a memory 204 storing a UI task automation component 206. The system 200 includes a Define Component 208, a Teach Component 210, a Validate Component 212, and a Ready Component 214 with the UI task automation component 206 of a disclosed embodiment. System 200 enables a non-technical user to select the Define Component 208 for a define operational mode of a UI task automation program generation, enabling a user to select an automation structure and inputs and outputs of the structure to create a task automation. System 200 enables a non-technical user to select the Teach Component 210 for a teach operational mode of a UI task automation program generation, and provides multi-modal UI interfaces to enable the user to perform one or more teaching demonstrations for the task automation. System 200 enables a non-technical user to select the Validate Component 212 for a validate operational mode of a UI task automation program generation, and provides a flow of UI operations and screens for the user to determine whether the complete UI task automation program performs correctly.

In a disclosed embodiment, system 200 includes a UI Task Automation List 220 storing multiple task automation applications or programs, for example including multiple task automation programs identified by the user as ready for production with the Ready Component 214 of the UI task automation component 206. For example, the user confirms the automation specification and validates behavior, system 200 presents to the user of a given complete task automation program (e.g., digital labor or bot) as ready for production. In a disclosed embodiment, when determined that a given UI task automation program fails to perform correctly, system 200 generates user guidance to fix or remove teaching demonstrations, which otherwise create inconsistencies during the program synthesis. Further, for example, system 200 can generate user guidance to provide the user with suggestions for additional teaching demonstrations and provides multi-modal interfaces to process one or more additional teaching demonstrations. System 200 updates the UI Task Automation List 220 with a complete task automation program, for example when identified by the user as ready for production.

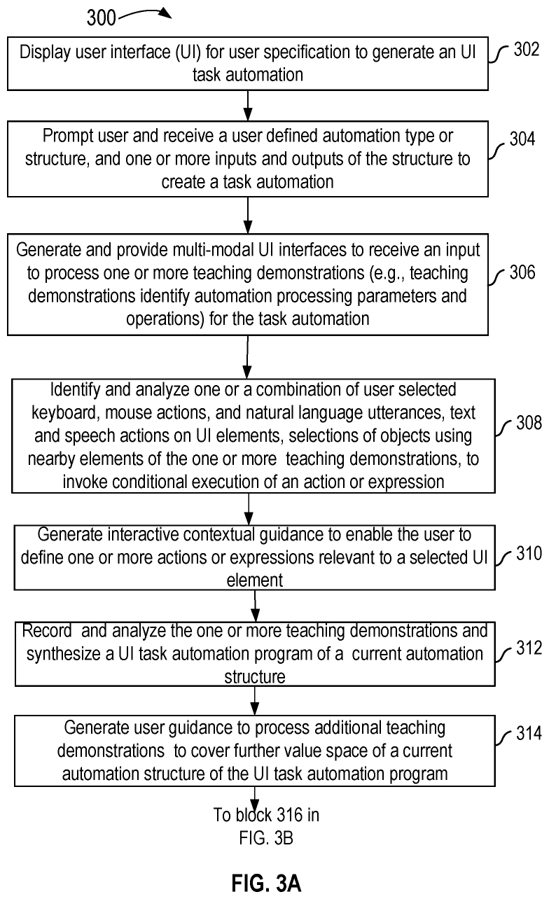

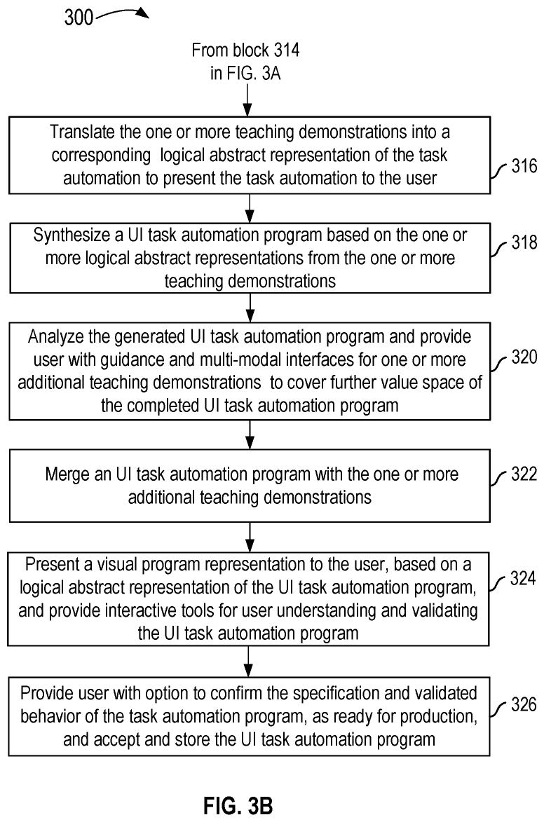

FIGS. 3A and 3B together illustrate example operations of a method 300 for implementing enhanced UI Task Automation of one or more disclosed embodiments. In a disclosed embodiment, method 300, for example implemented by system 200 in conjunction with the UI Automation Task Control Code 182, and computer 101 of FIG. 1, generates a UI Task Automation program in accordance with one or more disclosed embodiments. As shown, method 300 includes example operations performed by system 200 to enable generation of a UI Task Automation program by a non-technical user, without requiring programming skills.

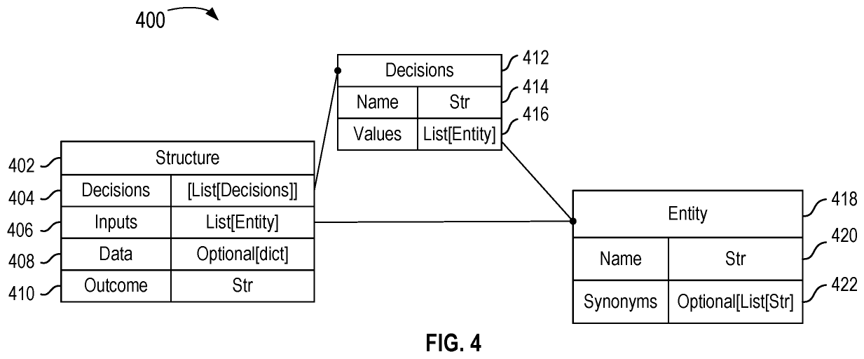

As shown at block 302, system 200 displays a user interface (UI) to enable a user specification to generate a UI task automation program. At block 304, system 200 starts the define operational mode where the system 200 prompts the user and receives a user defined automation type, template or structure, and one or more inputs and outputs of the structure to create a task automation. In a disclosed embodiment, system 200 prompts, and presents graphical visual metaphors to the user, to provide definitions for the automation type structure, and one or more inputs, and outputs of the structure to create the task automation. In a disclosed embodiment, the structure includes a name of the automation, the automation type and inputs and outputs (e.g., an existing file, such as an Excel file, and receives an Excel input and Excel output), a type of inputs and outputs or outcome (e.g., decision, extraction), and value space (e.g. decision A, B, C as strings). An example structure 402 of disclosed embodiments is illustrated and described with respect to FIG. 4.

At block 306, to enable the user to provide one or multiple teaching demonstrations (e.g., scenarios), system 200 generates and provides multi-modal UI interfaces to receive an input to process one or more teaching demonstrations for the task automation, where the one or more teaching demonstrations identify automation processing parameters and operations for the task automation. In a disclosed embodiment, system 200 provides multi-modal UI interfaces including input multi-modal interfaces (e.g., enabling the user to type or click and/or speak inputs), and provides output multi-modal interfaces or output modalities (e.g., enabling the user to visualize the created step, and to receive auditory feedback of the created step with a name and details). In a disclosed embodiment, the generated multi-modal UI interfaces enable keyboard and mouse actions on UI elements, and selections of objects using nearby elements, natural language text and speech actions of a given task automation. In a disclosed embodiment, system 200 can use natural language actions to invoke an action in one or more multi-modal UI interfaces, provide documentation and narration for the process, or name, such as a business entity, that the user can reference later (e.g. “this is the search results”). In a disclosed embodiment, system 200 records one or more of keyboard entries, mouse interactions, and natural language utterances of each teaching demonstration.

At block 308, system 200 identifies and analyzes the keyboard and mouse actions on elements, the selections of objects using nearby elements, natural language text, and natural language speech actions, for example to automatically invoke conditional execution of one or more actions or expressions, (e.g., Boolean expressions) of primitive actions and multi-modal primitive events and operations of the task automation or digital labor bot. In an embodiment, system 200 captures semantic actions from the teaching demonstration, and can attach the semantic action to an element of an abstract syntax or structure, and define additional processing on abstract tree nodes, (e.g., enable a node to perform one or more of semantic checking, identifying automation parameters, declaring variables and variable scope, and multi-modal primitive events including keyboard and mouse actions and natural language actions).

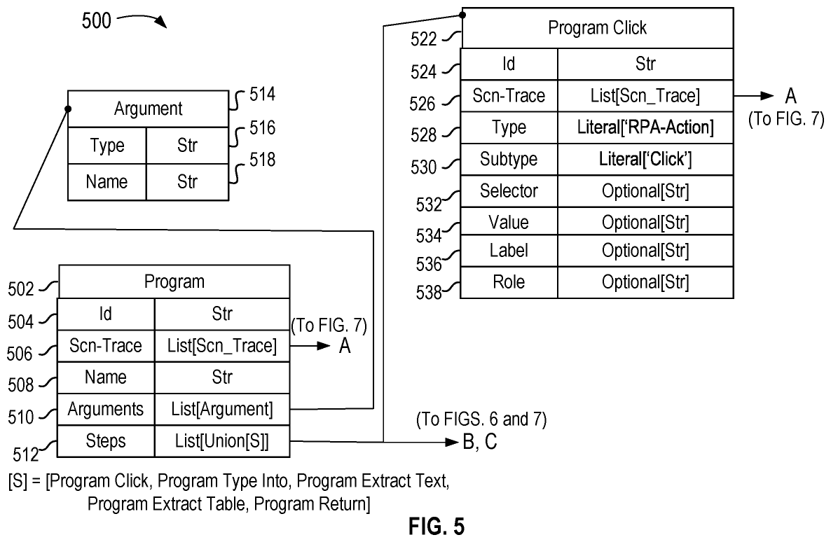

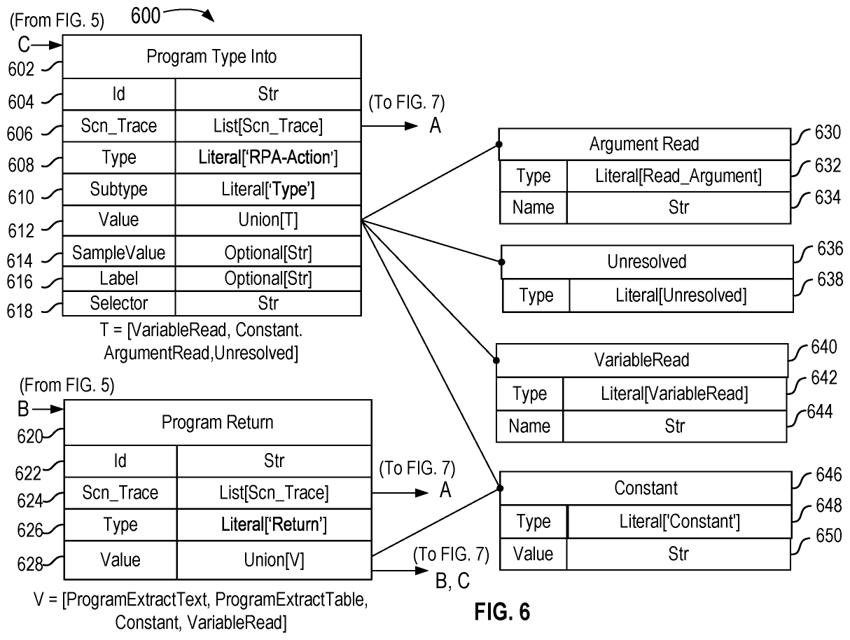

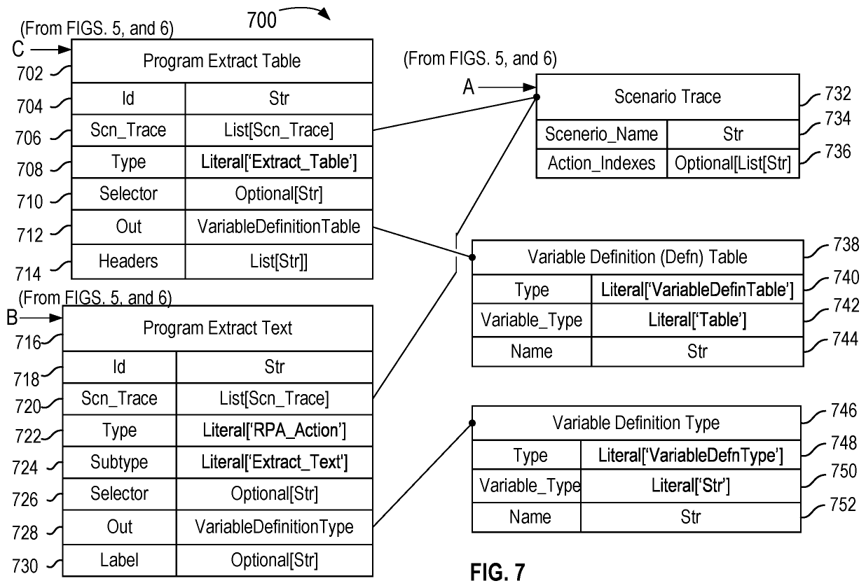

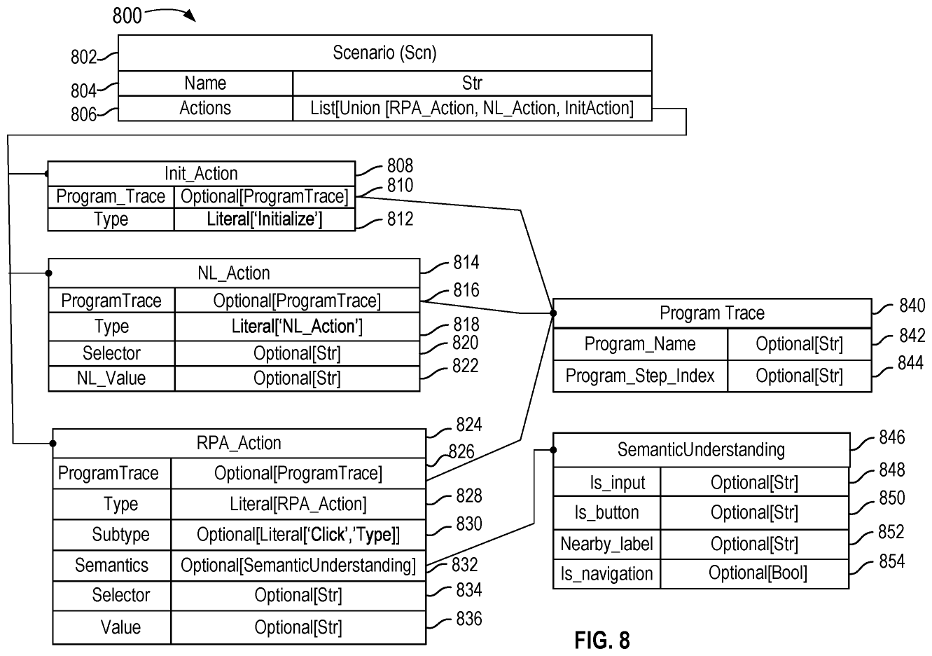

At block 310, system 200 provides the user with interactive contextual guidance to enable the user to define actions and expressions relevant to a selected UI element. In a disclosed embodiment, system 200 records conditional execution based on states of one or more UI elements, with the user selecting a UI element on the screen, the system provides, using an automated in-context advisor tool, automatic user guidance for the user to define one or more actions or expressions that are relevant to the selected UI element. In an embodiment, system 200 provides context information relevant to the automation task and provides interactive contextual guidance to help the user define actions and expressions on UI element, such as explaining and providing one or more examples and options for user selection to use the UI element for a given outcome or result. In an embodiment, the user can select an object based on nearby textual information, system 200 computes possible logical actions for that object (e.g., including Boolean or other expressions), and enables the user to select one or more of the possible logical actions. In an embodiment, system 200 enables natural language actions to invoke an action in the UI element, and provides documentation or narration for the process, or name an entity that the user will later want to use (e.g., to identify selected the search results). System 200 performs automatic computations and semantic analysis, and enables users to record multiple execution scenarios corresponding to different situations via keyboard and mouse interactions, and through natural language utterances. System 200 enables users to record conditional execution based on states of UI elements, by the user selecting an element on a UI screen (e.g., a given multi-modal UI interface), and system 200 provides automatic guidance on Boolean expressions that are relevant to the selected elements. Example logical automation structures used by system 200 for implementing teaching demonstrations, or Scenarios, are provided in FIGS. 5, 6, and 7, and in FIG. 8.

At block 312, system 200 records and analyzes the one or multiple teaching demonstrations, and synthesizes a UI task automation program of a current automation structure of the task automation. At block 314, system 200 provides the user with guidance to process additional teaching demonstrations or scenarios that are relevant for the current automation structure and UI task automation program. In a disclosed embodiment, system 200 suggests one or more teaching demonstrations to process, and enables another teaching mode to process the one or more additional teaching demonstrations for the task automation. For example, system 200 system provides the user with suggestions for additional scenarios to record additional value in the automation structure, or to fix or remove scenarios, which otherwise create inconsistencies during the program synthesis. Operations continue at block 316 in FIG. 3B.

Referring to FIG. 3B, at block 316, system 200 translates the one or multiple teaching demonstrations into a corresponding logical abstract representation of the task automation. In a disclosed embodiment, system 200 automatically detects program parameters from teaching demonstrations (e.g., by similarity of input fields and UI fields, and similarity of values) and records those program parameters in the demonstrated scenario when translating the one or multiple teaching demonstrations. In a disclosed embodiment, system 200 combines multiple automation actions into a single logical action in the logical abstract representation of respective teaching demonstrations to enable user understanding, to provide the logical abstract representation that is easier for a non-technical user to comprehend. For example, system can combine multiple computations and actions to present one logical action for review by the user without showing details of such computations and actions. In a disclosed embodiment, system 200 surfaces or presents a visual program representation to the user, based on the logical abstract representation of respective teaching demonstrations to enable user understanding.

At block 318, system 200 synthesizes a UI task automation program based the one or multiple teaching demonstrations or scenarios. At block 320, system 200 analyses the generated UI task automation program and provides the user with guidance and multi-modal interfaces to perform one or more further additional teaching demonstrations or scenarios to cover further value space of the current automation structure of the UI task automation program. At block 322, system 200 synthesizes, or merges the one or multiple teaching demonstrations or scenarios into a coherent UI task automation program including the one or more additional teaching demonstrations.

At block 324, system 200 surfaces or presents a visual program representation based on a logical abstract representation of the UI task automation program. In a disclosed embodiment, system 200 provides the user with interactive tools for understanding and validating the UI task automation program. In accordance with a disclosed embodiment, system 200 provides the ability for the user to view operation the UI task automation program performing the defined task automation on sample test data, for example representing different scenarios, and system 200 provides a live graphical view of a program map execution for each test data. In a disclosed embodiment, system 200 presents graphical visual metaphors to the user for a single teaching demonstration or scenario and for the complete UI task automation program. At block 326, system 200 provides the user with option to confirm the specification, and the validated behavior of the UI task automation program, as ready for production, and then system 200 accepts and stores the UI task automation program, for example, for access at UI Task Automation Application List 220 of FIG. 2.

FIG. 4 illustrate automation structure 400 for implementing example defining inputs, outputs and decision values of UI Task Automation of one or more disclosed embodiments. In a disclosed embodiment, automation structure 400 illustrates an example automation structure for a define operational mode, implemented by system 200 in conjunction with the UI Automation Task Control Code 182, and computer 101 of FIG. 1 to build or generate a UI Task Automation program in accordance with one or more disclosed embodiments. The define operational mode enabled by automation structure 400 enables defining inputs, outputs, and decision values as described with respect block 304 of FIG. 3. As shown, the automation structure 400 includes a template of an automation type or automation Structure 402. Automation Structure 402 includes one or more Decisions 404 with [List [Decisions]], one or more Inputs 406 with List [Entity], Data 408 with Optional [dict], and outputs or Outcome 410 with value string (Str) used to create a task automation. In a disclosed embodiment, the [List [Decisions]] of the one or more Decisions 404 is represented by an example Decisions 412 including a Name 414 with value Str, and Values 416 with List [Entity] of the automation Structure 400. In a disclosed embodiment, each of the List [Entity] of the one or more Inputs 406 and the List [Entity] of the one or more Values 416 is represented by an example Entity 418. As shown, the Entity 418 includes a Name 420 with value Str, and Synonyms 422 with an Optional [List (Str)]. In a disclosed embodiment, the Inputs 406 and Outcome 410 of automation Structure 402 can include an existing spreadsheet or database file, and a database input, and database output, a type of inputs and outputs (e.g., Decisions 412, Outcome 410), and Values 416 (e.g., decision A, B, C as strings).

FIGS. 5, 6, and 7 together respectively illustrate example logical automation structures 500, 600, and 700 for implementing a UI Task Automation of disclosed embodiments. In a disclosed embodiment, automation structures 500, 600, and 700 generate a UI Task Automation program implemented by system 200 in conjunction with the UI Automation Task Control Code 182, and computer 101 of FIG. 1 in accordance with one or more disclosed embodiments. The logical automation structures 500, 600, and 700 include high-level logical structures presented to the user, that the end user can understand, as well as low-level logical structures not presented to the user.

In FIG. 5, the logical automation structure 500 includes a Program 502 for implementing UI Task Automation of disclosed embodiments. As shown, Program 502 includes an identification (Id) 504 with a value string Str, and a Scenario_Trace or Scn_Trace 506 with a List [Scn_Trace], where Scenario, or Scn, also is called a teaching demonstration and used interchangeable with a teaching demonstration of disclosed embodiments in the following description. An example Scenario_Trace 732 is illustrated and described with respect to FIG. 7 following entry point A. As shown, Program 502 includes a Name 508 with value Str, Arguments 510 with List [Argument], and Steps 512 with List [Union [S]]. In a disclosed embodiment, for example, S in Steps 512 is defined as or represents:
S=Program Click, Program Type Into, Program Extract Text, Program Extract Table, and Program Return.

Respective example logical automation structures of Program 502 are illustrated and described with respect to Program Click 522 in FIG. 5, Program Type Into 602 and Program Return 620 respectively following entry points C, and B in FIG. 6, and Program Extract Table 702 and Program Extract Text 716 respectively following entry points C, and B in FIG. 7.

As shown in FIG. 5, an example logical automation structure of Arguments 510 includes Argument 514 including Type 516 with value Str, and Name 518 with value Str. As shown, Program Click 522 includes Id 524 with value Str, and a Name 526 with value Str, and a Scenario_Trace or Scn_Trace 526 with a List [Scn_Trace], where the illustrative example Scenario_Trace 732 is illustrated and described with respect to FIG. 7 following entry point A. Program Click 522 includes a Type 528 with Literal [RPA_Action], and a Subtype 530 with Literal [‘Click’], where respective literal RPA actions and Click or keyboard entries can be maintained. Program Click 522 includes a Selector 532, a Value 534, a Label 536, and a Role 538, each together with an Optional value Str.

In FIG. 6, the logical automation structure 600 includes illustrative examples of the Program Type Into 602 and Program Return 620. As shown, Program Type Into 602 includes Id 604 with value Str, Scn_Trace 606 with a List [Scn_Trace], a Type 608 with Literal [RPA_Action], and a Subtype 610 with Literal [‘Type’], where the example Scenario_Trace 732 is illustrated and described with respect to FIG. 7 following entry point A. The Program Type Into 602 includes Value 612 with Union [T], where T is defined as or represented by:
T=Variable Read, Constant, Argument Read, and Unresolved

Illustrative examples of logical automation structures of T include Variable Read 640, Constant 646, Argument Read 630, and Unresolved 636, as shown in FIG. 6. As shown, Program Type Into 602 includes Sample Value 614 and Label 616, each with an Optional value Str, and a Selector 618 with a value Str. As shown, Argument Read 630 includes a Type 632 with Literal [‘Read_Argument’], and a Name 634 with a value Str, and Unresolved 636 includes a Type 638 with Literal [‘Unresolved’].

As shown in FIG. 6, Program Return 620 includes Id 622 with value Str, Son_Trace 624 with a List [Scn_Trace] (i.e., the example Scenario_Trace 732 following entry point A in FIG. 7), and a Type 626 with Literal [‘Return’]. Program Return 620 includes a Value 628 with Union [V], where V is defined as or represented by:
V=Program Extract Text, Program Extract Table, and Constant, and Variable Read

Illustrative examples of logical automation structures of V include Program Extract Text 716, and Program Extract Table 702 respectively following entry points B, and C illustrated and described with respect to FIG. 7, and Constant 646, and Variable Read 640 as shown in FIG. 6. As shown, Constant 646 includes a Type 648 with Literal [‘Constant’], and a Value 650 with a value Str, and Variable Read 640 includes a Type 642 with Literal [‘Variable_Read’], and a Name 644 with a value Str.

In FIG. 7, the logical automation structure 700 includes the Program Extract Table 702 and Program Extract Text 716, following entry points C, and B, as referenced in in FIGS. 5 and 6 and the Scenario_Trace 732 following entry point A, also referenced in FIGS. 5 and 6. The logical automation structure 700 includes a Variable Definition Table 738, and a Variable Definition Type 746. In a disclosed embodiment, Program Extract Table 702 includes Id 704 with value Str, Scn_Trace 706 with a List [Scn_Trace] (i.e., with the example Scenario_Trace 732 shown following entry point A in FIG. 7), and a Type 708 with Literal [‘Extract_Table’]. Program Extract Table 702 includes a Selector 710 with an Optional [Str], Out 712 with a Variable Definition Table, and Headers 714 with a List [Str].

In a disclosed embodiment, Program Extract Text 716 includes an Id 718 with a value Str, Scn_Trace 720 with a List [Scn_Trace] (i.e., with Scenario_Trace 732 shown following entry point A in FIG. 7), a Type 722 with Literal [‘RPA_Action’], and a Subtype with Literal [‘Extract_Text’]. Program Extract Text 716 includes a Selector 726 with an Optional [Str], Out 728 with a Variable Definition Type, and a Label 730 with an Optional [Str].

As shown in FIG. 7, Scenario_Trace 732 includes a Scenario_Name 734 with a value Str and Action_Indexes 736 with an Optional [List [Str]]. As shown in the illustrative example, the Variable Definition (Defin) Table 738 includes a Type 740 with a Literal [‘VariableDefinTable’], a Variable_Type 742 with a Literal [‘Table’], and a Name 744 with a value Str. For example the Variable Definition Type 746 includes a Type 748 with a Literal [‘VariableDefinType’], a Variable_Type 750 with a Literal [‘Str’], and a Name 752 with a value Str.

In a disclosed embodiment, the example automation structures 500, 600, and 700 of FIGS. 5, 6, and 7 are used together to record multi-modal primitive events to generate a UI Task Automation program responsive to receiving user inputs from a non-technical user, identifying primitive expressions and/or actions, and generating program traces. Program 502 in FIG. 5 of the UI Task Automation of disclosed embodiments maintains a reference to primitive actions, such as demonstrated in the teaching demonstrations or scenarios, for example as illustrated and described with respect to FIG. 8.

FIG. 8 illustrates example logical automation structures 800 of automation processing parameters and operations of a teaching demonstration or scenario of disclosed embodiments. The logical automation structures 800 include an example list of multi-modal primitive events, including keyboard/mouse actions NL actions, of the teaching demonstration or Scenario 802. The illustrated Scenario 802 includes a Name 804 with a value Str and Actions 806 with a List [Str]. Actions 806 include one or more of Init_Action 808, NL_Action 814, or RPA_Action 824, as shown. For example, system 200 identifies and processes a list of Initialize actions, NL actions, and RPA actions together for implementing teaching demonstrations or scenarios UI Task Automation of one or more disclosed embodiments.

In a disclosed embodiment as shown, the Init_Action 808 includes a Program_Trace 810 with an Optional [Program_Trace], and a Type 812 with a Literal [‘Initialize’]. For example, the NL_Action 814 includes a Program_Trace 816 with an Optional [Program_Trace], and a Type 818 with a Literal [‘NL_Action’], a Selector 820 with an Optional [Str], and an NL_Value with an Optional [Str]. For example, the RPA_Action 824 includes a Program_Trace 826 with an Optional [Program_Trace], and a Type 828 with a Literal [‘RPA_Action’], a Subtype 830 with an Optional [Literal [‘Click’, ‘Type’]]. For example, the RPA_Action 824 includes a Semantics 832 with an Optional [SemanticUnderstanding], a Selector 834 with an Optional [Str], and a Value 836 with an Optional [Str].

In a disclosed embodiment, the teaching demonstration or Scenario 802 includes an automation structure Program Trace 840 for defining the Program_Trace 810 of the Init_Action 808, the Program_Trace 816 of the NL_Action 814, and the Program_Trace 826 of the RPA_Action 824. The Program Trace 840 comprises a Program_Name 842 with an Optional [Str], and a Program_Step_Index 844 with an Optional [Str].

In a disclosed embodiment, the Scenario 802 includes an automation structure Semantic Understanding 846 of primitive actions demonstrated in the scenarios of disclosed embodiments. Semantic Understanding 846 840 comprises an Is_input 848 with an Optional [Str], Is_button 850 with an Optional [Str], Nearby_label 852 with an Optional [Str], and Is_navigation 854 with an Optional [Str].

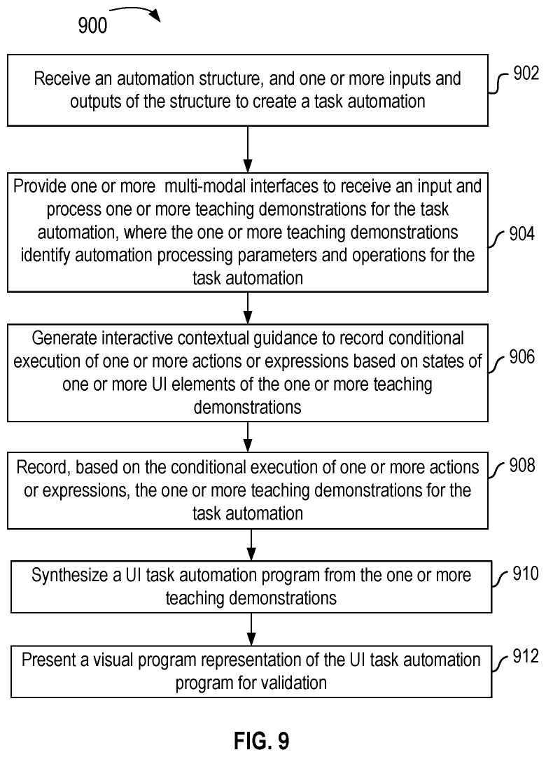

FIG. 9 illustrates a method 900 for implementing UI Task Automation of disclosed embodiments. Method 900 illustrates features and operations of methods 300, together with automation structures 400, 500, 600, 700, and 800 of disclosed embodiments. For example, method 900 is implemented by the system 200 in conjunction with the computer 101 of FIG. 1 with the UI Automation Task Control Code 182.

At block 902, system 200 receives an automation structure, or template, and one or more inputs and outputs of the automation structure to create a task automation. In a disclosed embodiment, system 200 prompts, and presents graphical visual metaphors, to the user to provide definitions for the automation structure, and the one or more inputs and outputs of the automation structure to create the task automation. At block 904, system 200 provides multi-modal interfaces to receive an input and to process one or more teaching demonstrations for the task automation, where the one or more teaching demonstrations identify automation processing parameters and operations of disclosed embodiments. The disclosed multi-modal interfaces include keyboard and mouse actions on UI elements of the task automation, selection of objects using nearby UI elements, natural language text and speech actions. For example, in a disclosed embodiment, system 200 enables use of natural language actions to invoke an action with the multi-modal interfaces, provide documentation and narration for the action or decision process, or name an entity for later user reference.

At block 906, system 200 generates interactive contextual guidance to enable the user to record conditional execution of one or more actions or expressions based on states of one or more UI elements of the task automation. The disclosed multi-interfaces, for example enable the user to select an object based on nearby textual information, system 200 computes, and transmits for display possible logical processing actions for that object (including expressions), and the user can select one of the logical processing actions. At block 908, system 200 records, based on the conditional execution of one or more actions or expressions, the one or more teaching demonstrations for the task automation. At block 910, system 200 synthesizes a UI task automation program from the one or more teaching demonstrations. In a disclosed embodiment, system 200 analyzes the teaching demonstrations and can automatically synthesize or merge multiple teaching demonstrations into a consistent UI task automation program. At block 912, system 200 presents a visual program representation of the UI task automation program for validation. For example, system 200 performs the UI task automation program to display a sequence of UI operations and screens for review by the user to validate behavior of the UI task automation program.

While the foregoing is directed to embodiments of the present invention, other and further embodiments of the invention may be devised without departing from the basic scope thereof, and the scope thereof is determined by the claims that follow.

What is claimed is:

1. A method comprising:
receiving an automation structure, and one or more inputs and outputs of the automation structure to create a task automation;
providing multi-modal interfaces to receive an input and process one or more teaching demonstrations for the task automation, wherein the one or more teaching demonstrations identify automation processing parameters and operations for the task automation;
generating interactive contextual guidance to record conditional execution of one or more automation actions or expressions based on states of one or more User Interface (UI) elements of the one or more teaching demonstrations;
recording, based on the conditional execution of one or more actions or expressions, the one or more teaching demonstrations;
synthesizing a UI task automation program from the one or more teaching demonstrations; and
presenting a visual program representation of the UI task automation program for validation.

2. The method of claim 1, further comprising:
analyzing the UI task automation program; and
generating user guidance and providing the multi-modal interfaces to process one or more additional teaching demonstrations.

3. The method of claim 1, further comprising:
translating the one or more teaching demonstrations into at least one logical abstract representation of the task automation; and
wherein presenting the visual program representation of the UI task automation program is based on the at least one logical abstract representation.

4. The method of claim 3, wherein translating the one or more additional teaching demonstrations into the at least one logical abstract representation of the task automation further comprises combining multiple automation actions into one logical action in the at least one logical abstract representation of the task automation to present for user understanding.

5. The method of claim 1, wherein generating the interactive contextual guidance further comprises generating the interactive contextual guidance to enable a user to select at least one automation action or expression on at least one UI element.

6. The method of claim 1, wherein receiving the automation structure further comprises prompting, and presenting graphical visual metaphors, to receive user selected definitions for the automation structure, and the one or more inputs and outputs of the automation structure to create the task automation.

7. The method of claim 1, wherein presenting the visual program representation of the UI task automation program further comprises providing at least one interactive tool with the visual program representation to enable user understanding and validating the UI task automation program.

8. The method of claim 1, wherein presenting the visual program representation of the UI task automation program further comprises enabling a user to accept and store the UI task automation program.

9. The method of claim 1, wherein recording, based on the conditional execution of the one or more actions or expressions, the one or more teaching demonstrations further comprises automatically detecting at least one program parameter from the one or more teaching demonstrations, and recording the at least one program parameter with the one or more teaching demonstrations.

10. The method of claim 1, wherein presenting the visual program representation of the UI task automation program further comprises performing the UI task automation program to display a sequence of UI operations and screens to validate behavior of the UI task automation program.

11. A system, comprising:
one or more computer processors; and
a memory containing a program which when executed by the one or more computer processors performs an operation, the operation comprising:
receiving a automation structure, and one or more inputs and outputs of the automation structure to create a task automation;
providing multi-modal interfaces, to receive an input and process one or more teaching demonstrations for the task automation, wherein the one or more teaching demonstrations identify automation processing parameters and operations for the task automation;
generating interactive contextual guidance to record conditional execution of one or more actions or expressions based on states of one or more User Interface (UI) elements of the one or more teaching demonstrations;
recording, based on the conditional execution of one or more actions or expressions, the one or more teaching demonstrations;
synthesizing a UI task automation program from the one or more teaching demonstrations; and
presenting a visual program representation of the UI task automation program for validation.

12. The system of claim 11, further comprising:
analyzing the UI task automation program; and
generating user guidance and providing the multi-modal interfaces to process one or more additional teaching demonstrations.

13. The system of claim 11, further comprising:
translating the one or more teaching demonstrations into at least one logical abstract representation of the task automation; and
wherein presenting the visual program representation of the UI task automation program is based on the at least one logical abstract representation.

14. The system of claim 11, wherein presenting the visual program representation of the UI task automation program further comprises performing the UI task automation program to display a sequence of UI operations and screens to validate behavior of the UI task automation program.

15. The system of claim 11, wherein presenting the visual program representation of the UI task automation program further comprises providing at least one interactive tool with the visual program representation to enable user understanding and validating the UI task automation program.

16. A computer program product comprising a computer-readable storage medium having computer-readable program code embodied therewith, the computer-readable program code executable by one or more computer processors to perform an operation comprising:
receiving an automation structure, and one or more inputs and outputs of the automation structure to create a task automation;
providing multi-modal interfaces, to receive an input and process one or more teaching demonstrations for the task automation, wherein the one or more teaching demonstrations identify automation processing parameters and operations for the task automation;
generating interactive contextual guidance to record conditional execution of one or more actions or expressions based on states of one or more User Interface (UI) elements of the one or more teaching demonstrations;
recording, based on the conditional execution of one or more actions or expressions, the one or more teaching demonstrations;
synthesizing a UI task automation program from the one or more teaching demonstrations; and
presenting a visual program representation of the UI task automation program for validation.

17. The computer program product of claim 16, further comprising:
analyzing the UI task automation program; and
generating user guidance and providing the multi-modal interfaces to process one or more additional teaching demonstrations.

18. The computer program product of claim 16, further comprising:
translating the one or more teaching demonstrations into at least one logical abstract representation of the task automation; and
wherein presenting the visual program representation of the UI task automation program is based on the at least one logical abstract representation.

19. The computer program product of claim 16, wherein presenting the visual program representation of the UI task automation program further comprises performing the UI task automation program to display a sequence of UI operations and screens to validate behavior of the UI task automation program.

20. The computer program product of claim 16, wherein presenting the visual program representation of the UI task automation program further comprises providing at least one interactive tool with the visual program representation to enable user understanding and validating the UI task automation program.
